(19) United States
(12) Patent Application Publication
(10) Pub. No.: US 2016/0217473 A1
(43) Pub. Date: Jul. 28, 2016

(54) Transparent Pigmented Polymer Security Printing

(71) Applicant: SCODIX LTD., Rosh Haain (IL)

(72) Inventor: Eli Grinberg, Pardesia (IL)

(21) Appl. No.: 14/912,179

(22) PCT Filed: Sep. 17, 2014
(86) PCT No.: PCT/IB2014/064584

§ 371 Date: Feb. 16, 2016

Related U.S. Application Data
(60) Provisional application No. 61/890,258, filed on Oct. 13, 2013.

(51) Int. Cl. G06Q 30/00; G06K 9/18; G06K 9/46; G06K 9/22; G06Q 10/08; G06K 9/20

(52) U.S. Cl. CPC G06Q 30/018; G06Q 10/087; G06K 9/2027; G06K 9/4652; G06K 9/228; G06K 9/186

(57) ABSTRACT

An authentication system comprising: at least one electronic communication device; and an authentication system server; wherein said at least one electronic communication device and said authentication system server are configured to communicate bi-directionally with each other; said at least one electronic communication device comprising a camera and a LED flash; said at least one electronic communication device configured to run a user application; said user application configured to authenticate a product unit via a variable code printed thereon with a transparent polymer comprising at least one pigment.

### CROSS-REFERENCE TO RELATED PATENT APPLICATIONS

This patent application claims priority from and is related to U.S. Provisional Patent Application Ser. No. 61/890,258, filed Oct. 13, 2013, this U.S. Provisional Patent Application incorporated by reference in its entirety herein.

### FIELD OF THE INVENTION

The present invention generally relates to security printing and specifically to transparent pigmented polymer security printing.

### BACKGROUND

Security printing is the field of the printing industry that deals with the printing of items such as banknotes, passports, tamper-evident labels, product authentication, stock certificates, postage stamps, identity cards and the like. The main goal of security printing is to prevent forgery, tampering, or counterfeiting. More recently many of the techniques used to protect these high-value documents have become more available to commercial printers whether they are using the more traditional offset and flexographic presses or the newer digital platforms.

A number of technical methods are used in the security printing industry.

One of the methods is printing in color changing inks. Color changing magnetizable inks are prepared by including chromatic pigments of high color strength. The magnetic pigments' strong inherent color generally reduces the spectrum of achievable shades. Generally, pigments should be used at high concentrations to ensure that sufficient magnetizable material is applied even in thin offset coats. Magnetic Pigment 340 BASF is best suited for colored magnetizable inks due to its lower blackness. Due to its spherical particles, Magnetic Pigment 025 BASF allows homogenous magnetization (no preferred orientation). Its remanence and coercive field strength are very low and the saturating magnetization is high. Magnetic Pigment 345 BASF and Magnetic Pigment 346 BASF are also used in ribbon inks for coding and reading (MICR=Magnetic Ink Character Recognition). The pigment is dispersed in a binder system (resin, solvent) or a wax compound and applied either by pressing or by hot melt to a carrier film (usually polyethylene).

When pearlescent pigments are viewed at different angles the angle of the light as its perceived makes the color appear to change as the magnetic fields within the particles shift direction.

### SUMMARY

According to a first aspect of the present invention there is provided an authentication system comprising: at least one electronic communication device; and an authentication system server; wherein said at least one electronic communication device and said authentication system server are configured to communicate bi-directionally with each other; said at least one electronic communication device comprising a camera and a LED flash; said at least one electronic communication device configured to run a user application; said user application configured to authenticate a product unit via a variable code printed thereon with a transparent polymer comprising at least one pigment.

The system may further comprise at least one producer server storing an inventory data base; wherein said authentication system server and said at least one producer server may be configured to bi-directionally communicate with each other.

The at least one electronic communication device may further be configured to run a shop owner application; said shop owner application may be configured to check the existence of said product unit in said inventory data base.

The code may be selected from the group consisting of: QR code, barcode, text, serial number and logo.

The transparent polymer may be selected from a group consisting of: UV cured polymer, UV acrylate and water based solvent.

The at least one electronic communication device may be selected from the group consisting of: smartphone and tablet.

The camera may be configured for capturing said printed code, said capturing comprising a first capture without using the camera's LED flash and a second capture using light of said LED flash; the system may further comprise processing means for extracting a color by finding a difference between said two captured codes and comparing said color to a predefined color; and user interface means for authenticating the product if said color equals said predefined color.

According to a second aspect of the present invention there is provided a method of authenticating a product unit comprising: capturing with a camera a first image of a code printed with a transparent polymer comprising at least one pigment on said product unit, without using the camera LED flash; capturing a second image of said code with said camera using said camera LED flash; extracting a color by finding a difference between said two captured images; comparing said color to a predefined producer's color; and providing an authentication message if said color equals said predefined color.

The code may be selected from the group consisting of: QR code, barcode, text, serial number and logo.

The transparent polymer may be selected from a group consisting of: UV cured polymer, UV acrylate and water based solvent.

The pigment may be selected from the group consisting of: fluorescent pigment and fluorescent dyes.

Finding a difference may comprise subtracting one of said images from the other.

The method may further comprise: extracting a value from said product unit code; communicating with a server storing an inventory database of said producer; if said value exists in the inventory database, marking said product unit as purchased; and otherwise, providing an alert massage.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic block diagram of the printing system of the present invention;

FIG. 2 is schematic block diagram of the authentication system of the present invention;

FIG. 3 is a flow chart of the user's product authentication process; and

FIG. 4 is a flow chart of the shop owner's product authentication process.

### DETAILED DESCRIPTION OF PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention offers a method of security printing by printing a transparent polymer comprising one pigment or a unique combination of pigments on a product. That pigment\combination reflects a unique color that is recognized by the system which authenticates the product.

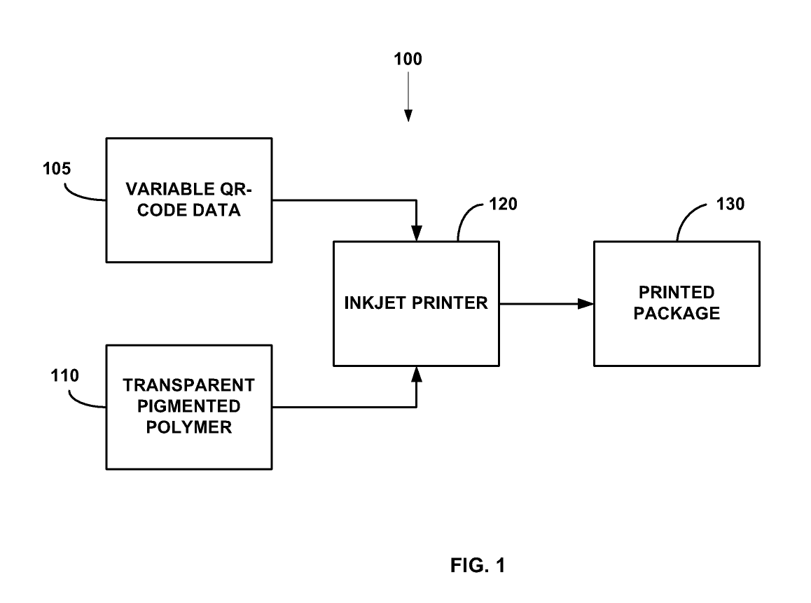

FIG. 1 is a schematic block diagram of the printing system 100 of the present invention.

Inkjet printer 120 obtains variable code data 105 and prints it with transparent pigmented polymer 110 on the product package 130. The printed data comprises a code, e.g. QR code, barcode, text, logo or any indicia that is printed on the package with a transparent polymer, such as UV cured polymer, UV acrylate, water based solvent and the like. The polymer comprises one or more pigments, such as fluorescent pigment, fluorescent dyes and the like.

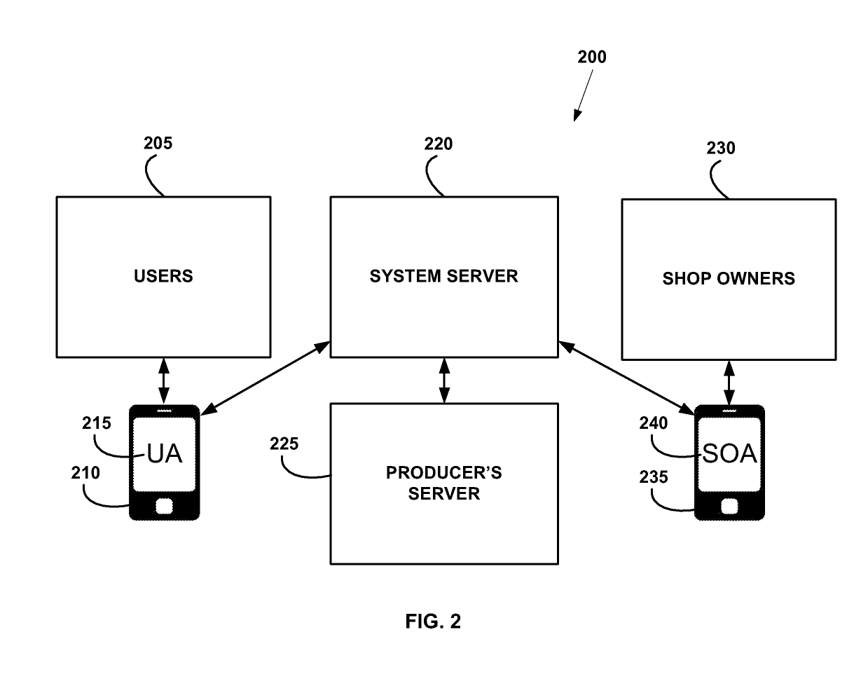

FIG. 2 is schematic block diagram of the authentication system 200 of the present invention. The system comprises users 205 each having an electronic communication device 210 (e.g. smartphone) running a user authentication application 215, an authentication system server 220, at least one producer's server 225 comprising at least one inventory database and shop owners 230 each having an electronic communication device 235 (e.g. smartphone) running a shop owner authentication application 240. The authentication system server 220 communicates bi-directionally with the electronic communication devices (210, 235). The authentication system server 220 may also communicate bi-directionally with at least one producer's server 225.

When excited by light of a given wavelength range the printed pigment(s) reflects light of a given wavelength or complex of wavelengths. The reflected light is captured by a digital camera and translated into a color value. The color value is used to authenticate the product. Each producer is identified by a unique color value.

The projected light and the camera are part of an electronic communication device, such as tablet, smartphone and the like.

In a preferred embodiment, the projected light and the camera are part of a smartphone (210, 235).

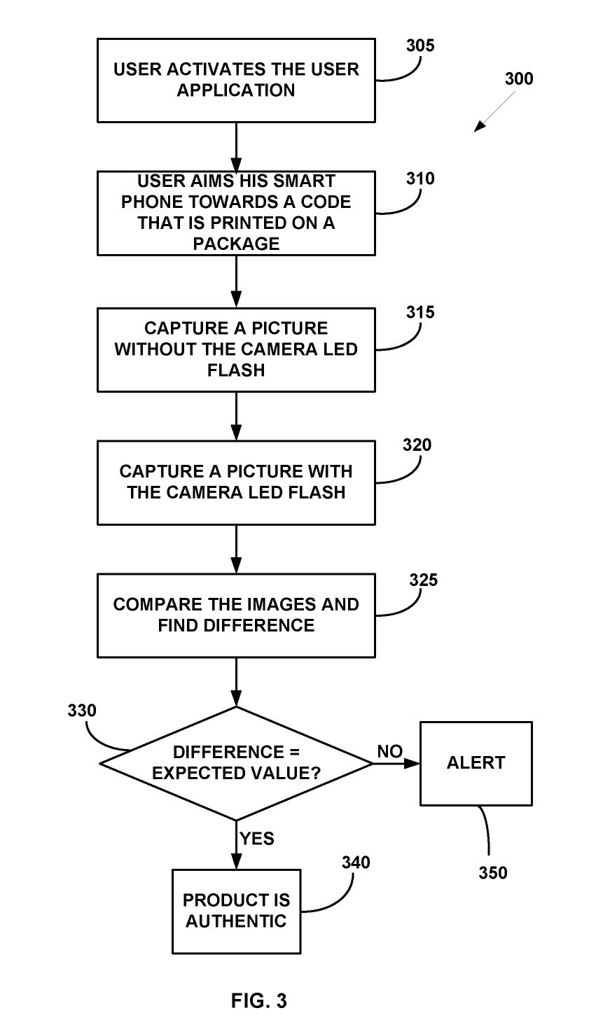

FIG. 3 is a flow chart 300 of the user's product authentication process.

The user activates the user application (step 305) and aims his smart phone towards a code that is printed on a package he wishes to check (step 310). The application is configured for a predefined producer, i.e. contains indicia of a predefined color value. In another embodiment, the user application may prompt the user to input the producer name and extract the expected indicia color value from a table residing in the user application or in the system server 220. The user application uses the smart phone camera to capture two pictures of the printed indicia, one without the camera LED flash (step 315) and the other with the camera LED flash (step 320). The application compares the images that were captured with and without the camera LED flash, e.g. by subtraction, and finds the difference (step 325). The difference indicates the excitation of the polymer by the LED and this is the unique color code that we are looking for. The color is analyzed in order to determine if the product is original (step 330), namely, if the captured color is equivalent to the expected color. If the color is valid the application approves that the product is original (step 340) and provides (e.g.

displays) an authentication message (e.g. on the smartphone's 210 screen) via a user interface. If not, a fraud alert is provided (step 350).

In addition to the product authentication by the color value of the transparent code, a singularity check is performed when a product is being sold. Each product unit has a unique code such as QR-Code representing e.g. a serial number, that differentiates it from other product units of the same producer, thus providing a double check that the product is original.

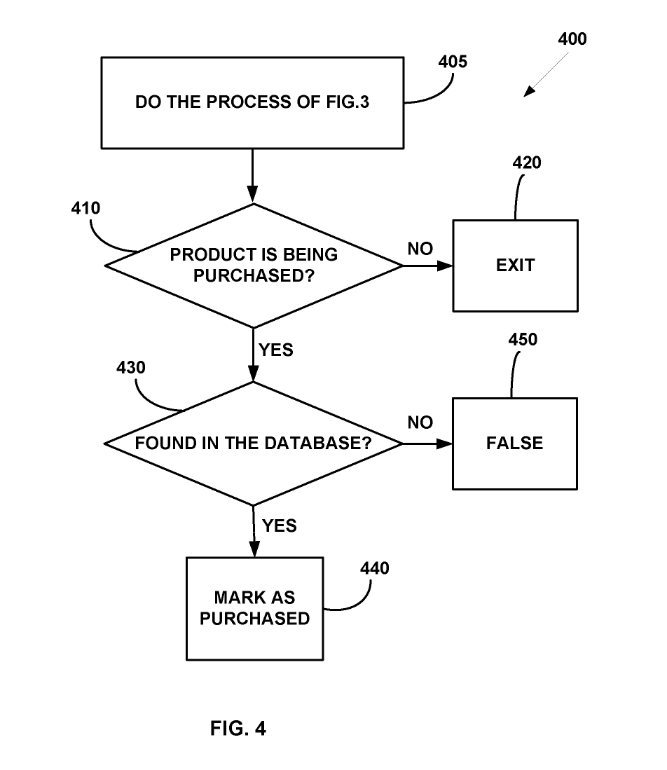

FIG. 4 is a flow chart 400 of the shop owner's product authentication process.

The shop owner application (240 of FIG. 2) is similar to the user application (215 of FIG. 2) and comprises additional steps for the singularity check. The process begins in step 405 by doing the same process of FIG. 3. Step 410 checks if the product is being purchased, if not, e.g. price check—exit 420, otherwise, step 430 checks if the code (not the color value) represents a product unit found in the producer's inventory. If it does, in step 440, mark the unit as purchased in the inventory. Otherwise, return FALSE 550, i.e. a product unit with same code has already been sold.

According to embodiments of the invention, the access to the producer's inventory may be done
directly, namely by bi-directional communication between the electronic communication device 235 and the producer's server 225;
indirectly via the system server 220, namely by bi-directional communication between the system server 220 and the producer's server 225;
via an inventory application that enables a bi-directional communication between the system server 220 and the producer's server 225 or between the electronic communication devices 235 and the producer's server 225;
or by any other method known in the art.

A big problem producers have to deal with is shop owners that buy products indirectly. Shop owners frequently buy products via other countries that sell the products cheaper.

The present invention offers a solution to this problem. Each product's code is allocated to a specific selling area. A producer, who is using the present invention's transparent security code, is able to monitor his products and see when and where they have been sold, thus preventing indirect buying by shop owners.

It will be appreciated by persons skilled in the art that the present invention is not limited to what has been particularly shown and described hereinabove. Rather the scope of the present invention is defined by the appended claims and includes combinations and sub-combinations of the various features described hereinabove as well as variations and modifications thereof which would occur to persons skilled in the art upon reading the foregoing description.

1. An authentication system comprising:
at least one electronic communication device; and
an authentication system server;
wherein said at least one electronic communication device and said authentication system server are configured to communicate bi-directionally with each other;
said at least one electronic communication device comprising a camera and a LED flash;
said at least one electronic communication device configured to run a user application;
said user application configured to authenticate a product unit via a variable code printed thereon with a transparent polymer comprising at least one pigment.

2. The system of claim 1, further comprising at least one producer server storing an inventory data base;
wherein said authentication system server and said at least one producer server are configured to bi-directionally communicate with each other.

3. The system of claim 2, wherein said at least one electronic communication device is further configured to run a shop owner application;
said shop owner application configured to check the existence of said product unit in said inventory data base.

4. The system of claim 1, wherein said code is selected from the group consisting of: QR code, barcode, text, serial number and logo.

5. The system of claim 1, wherein said transparent polymer is selected from a group consisting of: UV cured polymer, UV acrylate and water based solvent.

6. The system of claim 1, wherein said at least one electronic communication device is selected from the group consisting of: smartphone and tablet.

7. The system of claim 1 wherein said camera is configured for capturing said printed code, said capturing comprising a first capture without using the camera's LED flash and a second capture using light of said LED flash;
the system further comprising processing means for extracting a color by finding a difference between said two captured codes and comparing said color to a predefined color; and
user interface means for authenticating the product if said color equals said predefined color.

8. A method of authenticating a product unit comprising:
capturing with a camera a first image of a code printed with a transparent polymer comprising at least one pigment on said product unit, without using the camera LED flash;
capturing a second image of said code with said camera using said camera LED flash;
extracting a color by finding a difference between said two captured images;
comparing said color to a predefined producer's color; and
providing an authentication message if said color equals said predefined color.

9. The method of claim 8, wherein said code is selected from the group consisting of: QR code, barcode, text, serial number and logo.

10. The method of claim 8, wherein said transparent polymer is selected from a group consisting of: UV cured polymer, UV acrylate and water based solvent.

11. The method of claim 8, wherein said pigment is selected from the group consisting of: fluorescent pigment and fluorescent dyes.

12. The method of claim 8, wherein said finding a difference comprises subtracting one of said images from the other.

13. The method of claim 8, further comprising:
extracting a value from said product unit code;
communicating with a server storing an inventory database of said producer;
if said value exists in the inventory database, marking said product unit as purchased; and
otherwise, providing an alert massage.
